(19) United States
(12) Patent Application Publication
(10) Pub. No.: US 2018/0216913 A1
(43) Pub. Date: Aug. 2, 2018

(54) MODULAR POWERING SYSTEM FOR ARCHERY BOWS

(71) Applicant: Wilson Tool International Inc., White Bear Lake, MN (US)

(72) Inventors: Anthony David Schwartz, Forest Lake, MN (US); Thomas Steven Duppong, Woodbury, MN (US)

(21) Appl. No.: 15/887,206

(22) Filed: Feb. 2, 2018

Related U.S. Application Data
(60) Provisional application No. 62/453,766, filed on Feb. 2, 2017.

(51) Int. Cl. F41G 1/34; H01H 17/08; F41B 5/14; F41G 1/467

(52) U.S. Cl. CPC F41G 1/345; H01H 17/08; G02B 6/0008; F41G 1/467; F41B 5/1411

(57) ABSTRACT

A power module configured for use with archery bows to enhance use of the bows and/or provide other functionality.

### RELATED APPLICATIONS

This application claims priority to U.S. Provisional Patent Application No. 62/453,766, filed Feb. 2, 2017, the entire contents of which are incorporated herein by reference.

### FIELD OF THE INVENTION

The present invention relates generally to archery bows. More particularly, embodiments of the invention relate to a modular powering system for such bows, which can be selectively employed to enhance use of the bows and/or provide other functionality.

### BACKGROUND

There are many types of archery bows, such as recurves, compounds, longbows, and crossbows. Some of these bow types are specifically designed to ease use thereof. For instance, with compound bows and their use of cables and cam wheels, the force needed to maintain the drawstring at its pullback position is significantly less than the force needed to pull the string back to such position. As a result, there is less stress on the user when aiming at an intended target. Another bow type designed for ease of use is the crossbow, which requires no force to be applied on the drawstring by the user when aiming at a target.

As opposed to features that are inherent to the bow design (as exemplified above), other features can be selectively added, to again ease and/or enhance use of the bows. One common example of the add-on variety is an aiming sight; however, other well known examples include vibration dampeners, quivers, etc. Some of the add-on features may require power for functioning (e.g., certain sight designs), and as such these features are correspondingly configured with power sources.

Care must be taken, however, in equipping bows with add-on features. Clearly, the space available on a bow for mounting add-on features is limited. To that end, given the space that is available, one needs to ensure that the added features not hinder successful use of the bow. Additionally, for powered features, consideration must be directed to how the feature is to be powered, how the corresponding power source impacts the size/shape of the feature and its mounting to the bow, and how the power source is to be activated/triggered, while similarly keeping focus that none of the above adversely affects the user's use of the bow.

Embodiments of the present invention are intended to address the above-described design considerations (as well as others) with regard to archery bows.

### SUMMARY OF THE INVENTION

In some embodiments, a power module for an archery bow is provided. The power module comprises a mounting portion having a base configured for securing the module to an archery bow, an enclosure portion extending from the base and defining a cavity, and a power source and a switch mechanism. The power source and switch mechanism are situated in the cavity of the enclosure portion. The switch mechanism forms an input such that only by triggering the switch mechanism is power provided from the module. The power source forms an output whereby the power is provided by the module via the power source to one or more features requiring power for functionality. The one or more features are each mounted separate and at a distance from the power module. The triggering of the switch mechanism stems from one or more of a direct action and an indirect action performable by the user during active use of the archery bow.

In additional embodiments, a power module for an archery bow is provided. The power module comprises a mounting portion having a base configured for securing the module to an archery bow, an enclosure portion extending from the base and defining a cavity, a power source and a switch mechanism, and a linkage module interconnecting the power module and the one or more features, wherein the linkage module comprises an activation portion for each of the one or more features. The power source and switch mechanism are situated in the cavity of the enclosure portion. The switch mechanism forms an input such that only by triggering the switch mechanism is power provided from the module. The power source forms an output whereby the power is provided by the module via the power source to one or more features requiring power for functionality. The one or more features are each mounted separate and at a distance from the power module.

### BRIEF DESCRIPTION OF THE DRAWINGS

The following drawings are illustrative of particular embodiments of the present invention and therefore do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 is a side view of an archery bow that can be exemplarily utilized in accordance with certain embodiments of the invention.

FIG. 2 is a perspective view of an aiming sight that can be exemplarily utilized in accordance with certain embodiments of the invention.

FIG. 3 is a perspective view of a power module (with outer walls being shown as transparent) in accordance with certain embodiments of the invention.

FIG. 4 is a perspective partial view of another archery bow that is equipped with the power module of FIG. 3 in accordance with certain embodiments of the invention.

FIG. 5 is a perspective view of an exemplary linkage module (with outer walls being shown as transparent) in accordance with certain embodiments of the invention.

FIG. 6 is a perspective partial view of a further archery bow equipped with the power module of FIG. 3 linked to an aiming sight via the linkage module of FIG. 5 in accordance with certain embodiments of the invention.

FIG. 7 is a further perspective partial view of the archery bow of FIG. 6.

FIG. 8A is a perspective view of another power module (with outer walls being shown as transparent) in accordance with certain embodiments of the invention.

FIG. 8B is a front view of the power module of FIG. 8A.

FIG. 8C is a top view of the power module of FIG. 8A.

FIG. 9A is a perspective view of another exemplary linkage module (with certain outer walls thereof being shown as transparent) in accordance with certain embodiments of the invention.

FIG. 9B is a perspective view of activation portion of the linkage module of FIG. 9A.

FIG. 10 is a perspective view of an additional power module in accordance with certain embodiments of the invention.

FIG. 11 is a perspective view of a further power module in accordance with certain embodiments of the invention.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

FIG. 1 shows a side view of an archery bow 10 that can be exemplarily utilized in accordance with certain embodiments of the invention. As can be seen from its features, e.g., such as its cam wheels 12, 12′, the bow 10 is a compound bow. To that end, while embodiments are described herein with respect to compound bows, the invention should not be so limited. In particular, skilled artisans will appreciate that the embodiments are similarly applicable to other types of archery bows. Turning back to the bow 10 of FIG. 1, it is formed of a body 14 with a pair of limbs 16, 16′ extending therefrom, with the cam wheels 12, 12′ operatively connected to opposing ends of the limbs 16, 16′. Extending between the cam wheels 12, 12′ are timing cables 18 and the bow drawstring 20, and extending crosswise from the body 14 toward the cables 18 and drawstring 20 is a string separator 22.

As already described, in many ways, archery bows (such as the bow 10 of FIG. 1) can be augmented, via adding one or more features thereto, in order to ease and/or enhance use of the bows. For instance, as shown, the bow 10 can include an aiming sight 24, a vibration dampener 26, and/or other add-on features. To that end, if any of the add-on features need power for their functioning, they are generally configured with power sources (most often, batteries). However, this can lead to the features being quite sizable, which can be problematic, particularly when mounted to a structure having limited surface area, such as an archery bow. Additionally, these features, as a consequence of incorporating the power sources, would tend to be more complex in their designs.

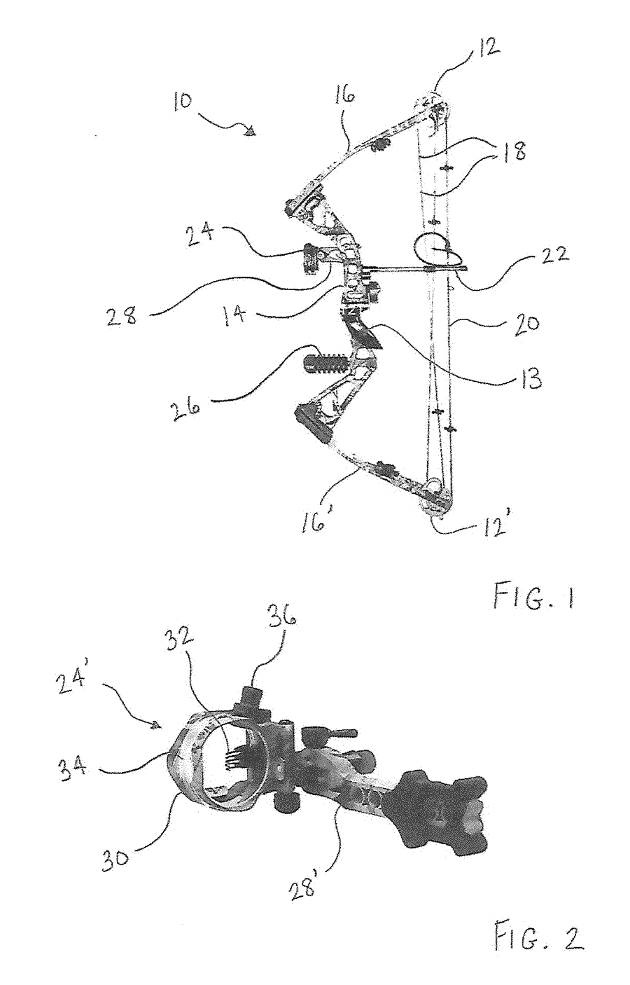

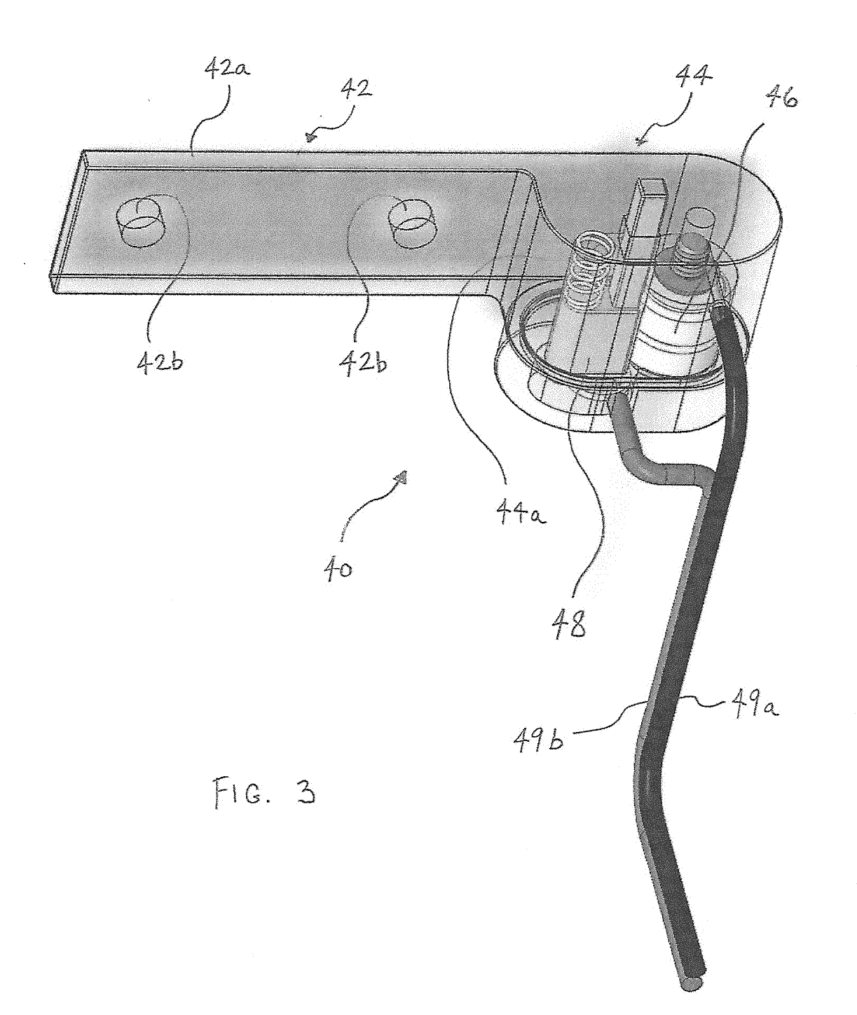

Continuing with FIG. 1, in certain embodiments, the aiming sight 24 of the bow 10 is coupled to the body 14 via one or more interconnecting brackets 28. Such a configuration is illustrated with greater detail in FIG. 2, which shows a side perspective view of a further aiming sight 24′ (which is of similar design to the sight 24 of FIG. 1, yet has alternate mounting bracketry 28′). To that end, there are many designs of aiming sights commercially available for archery bows (as well as differing mounts that can be used therewith). As such, it should be appreciated that the sight 24′ of FIG. 2 would be adaptable to the bow 10 of FIG. 1, as well as others. As shown, the sight 24′ includes an eyeglass-shaped housing 30, within which one or more target pins 32 extend. As skilled artisans would appreciate, sights utilizing a plurality of target pins are generally configured so that each pin corresponds to a different target distance. Alternately, a design with a single pin would commonly be used with a range indicator for targeting.

Regardless of their pin design, these types of aiming sights often necessitate a power source so that the target pins 32 can be illuminated as needed. Skilled artisans would appreciate such functionality is particularly useful during dusk and dawn hours, which often coincide with the times of day that game (wildlife) is most active. Turning back to the aiming sight 24′ of FIG. 2, its design involves the pins 32 being connected to fiber-optic cable 34. While shown as being wound about the sight's outer housing 30, the cable 34 can be alternately configured, e.g., being positioned differently, having different dimensions, etc., so long as it is exposed to the environment. As such, and to the extent there is ambient light directed at the cable 34, the light can pass there through to illuminate the pins 32. However, in low light settings, an alternate light source is needed (which generally dictates a power source for powering such light source). To that end, some light source designs have involved assemblies having a light source (e.g., one or more LEDs), a power source (e.g., one or more batteries), and a switch for activating the light source via the power source (e.g., push button). With reference to FIG. 2, such an assembly 36 is shown as part of the sight 24′, particularly being mounted on the sight's outer housing 30.

With continued reference to FIG. 2, skilled artisans would appreciate that the design has certain limitations. For example, perhaps because it is attached to the sight 24′, the light source assembly 36 has a somewhat compact design; however, this would tend to limit the size and quantity of batteries that can be used therewith. Further, and with reference back to FIG. 1, the aiming sight 24 is shown to be distanced from the user's hands when the bow 10 is being use (i.e., one hand being on the grip 13 and the other on the drawstring 20). To that end, and in view of the mounting configuration shown in FIG. 2 (i.e., with the light source assembly 36 attached to the sight 24′), once the drawstring 20 has been pulled back, there is no easy manner to contact the assembly 36 and thereby activate the light source thereof, without releasing the drawstring 20.

Skilled artisans would appreciate how the above-noted limitations could also apply to other add-on features requiring power for functionality. However, a further concern, with respect to use of multiple add-on features requiring power, is that there is presumably duplication of sub-parts amongst their power sources, and thus increased potential of issues collectively arising therefrom.

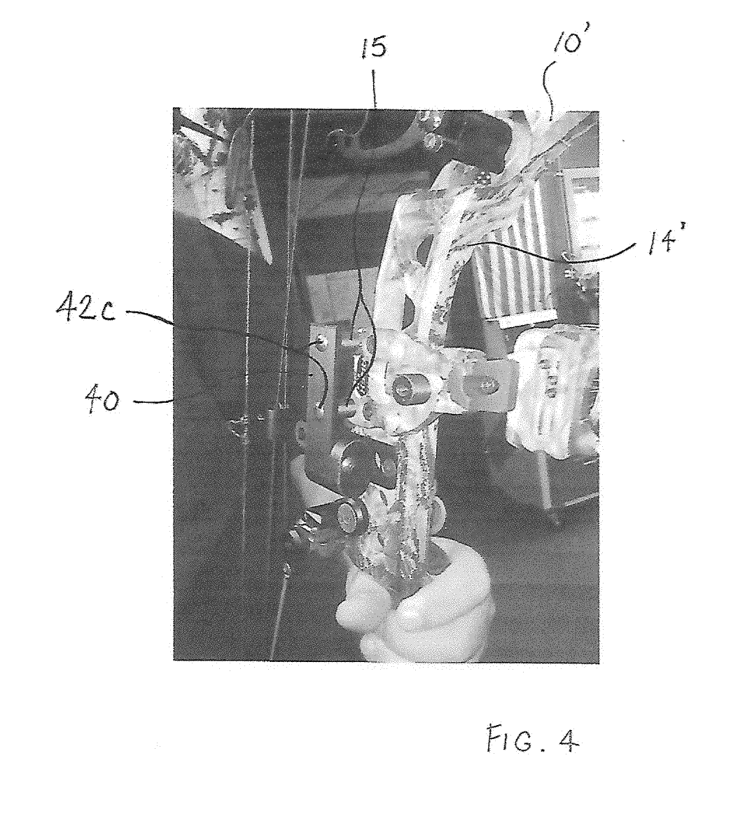

In addressing the above concerns (and others), attention is initially directed to FIG. 3, showing a power module 40 (with its outer walls being shown as transparent) in accordance with certain embodiments of the invention. As will be detailed herein, the power module 40 is configured for use with archery bows, such as the bow 10 of FIG. 1 as well as others, particularly to enhance use of the bows and/or provide other functionality. In certain embodiments, as shown, the module 40 has a mounting portion 42 and an enclosure portion 44. The mounting portion 42 is used in operably coupling the module 40 to the bow. In certain embodiments, as shown, the mounting portion 42 can be formed of a base 42a, which is adapted for such operable coupling. For example, as further illustrated, the base 42a can be defined with one or more bores 42b. To that end, reference is made to FIG. 4, which illustrates a partial view of further archery bow 10′, with the module 40 operably coupled thereto in accordance with certain embodiments of the invention. As shown, the bores 42b of the mounting portion 42 are configured to align with corresponding bosses 15 extending from the bow 10′ (via bracketry attached to the bow body 14′), and bolts 42c are used to extend through the bores 42b and be threadedly received by the bosses 15.

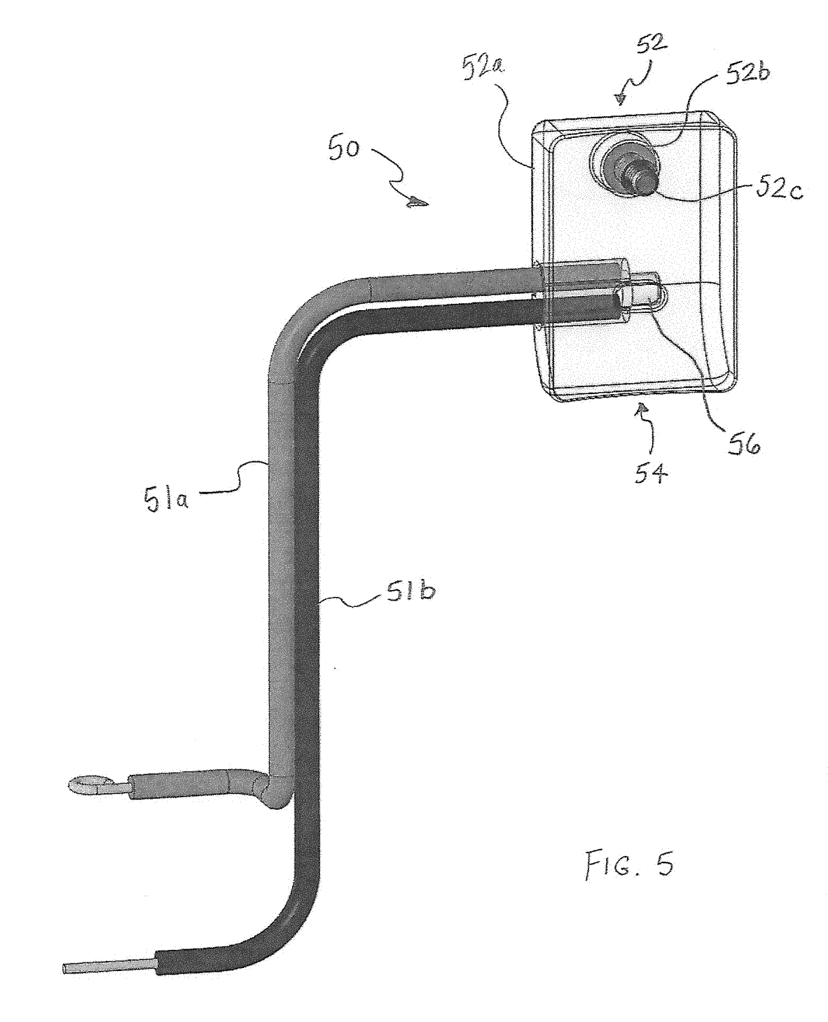

Turning back to FIG. 3, focus is next directed to the enclosure portion 44 of the power module 40. As shown, the enclosure portion 44 defines a cavity 44a. In certain embodiments, a power source 46 and a switch mechanism 48 are situated in the cavity 44a. Extending from each of the power source 46 and switch mechanism 48, respective leads 49a and 49b are further illustrated and between which a voltage can be provided via the power source 46 when the switch mechanism 48 is activated or triggered. As will be further detailed herein, the power module 40 can be used to serve as a power source for any quantity of add-on features for the archery bow, as is desired. To that end, while only one set of output leads 49a, 49b is illustrated in FIG. 3A, such is done for simplicity to outline an initial embodiment with reference to FIGS. 5-7. However, it should be appreciated that the embodiments of the invention can be expanded upon in a variety of manners, not only with respect to the output of the power module 40 (as alluded to above), but also with respect to the module's input.

Starting with FIG. 5, an exemplary linkage module 50 is shown (with its outer walls being shown as transparent) in accordance with certain embodiments of the invention. As illustrated, the linkage module 50 has a pair of leads 51a and 51b extending therefrom. It should be appreciated that these leads 51a and 51b correspond to the leads 49a and 49b of the power module 40. As such, these lead pairings could be correspondingly joined in coupling the modules 40, 50. Although, in certain embodiments, a solitary pair of leads can just as well be used in connecting the power and linkage modules 40 and 50. Continuing with reference to FIG. 5, the linkage module 50 is shown both with a mounting portion 52 and an activation portion 54. However, as later described herein, linkage modules for other add-on features may only necessitate an activation portion.

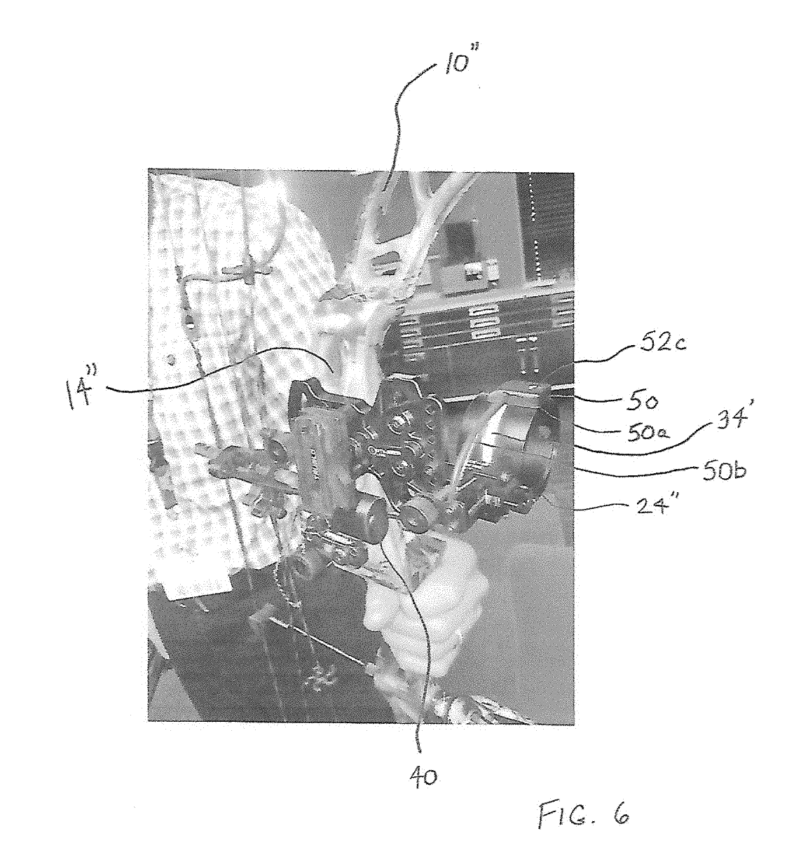

In certain embodiments as shown, the mounting portion 52 can be used in securing the linkage module 50 to the corresponding add-on feature of the archery bow. To that end, in certain embodiments, the mounting portion 52 can be formed of a base 52a which is adapted for coupling to the intended add-on feature. For example, as further illustrated, the base 52a can be defined with a bore 52b for fastening the module 50 (via bolt 52c). Reference is made to FIGS. 6 and 7, which show partial views of a further archery bow 10″ equipped with the power module 40, which is linked to an aiming sight 24″ via the linkage module 50 in accordance with certain embodiments of the invention. To that end, and as alluded to above, a single pair of leads 50a, 50b is used in connecting the power module 40 to the linkage module 50. In certain embodiments, as further described below, the leads 50a, 50b could be sheathed together via a single cable extending from the power module 40 to linkage module 50.

Turning back to FIG. 5, focus is directed to the activation portion 54 of the linkage module 50. As shown, the leads 51a and 51b are brought together such that the voltage there between (provided via the power module 40 of FIG. 3) can be delivered to the add-on feature, as applicable. For example, the leads 51a, 51b of the linkage module 50 of FIG. 5 are shown as tied to a light source 56, e.g., one or more LEDs. Shifting back to FIGS. 6 and 7, in operably coupling the linkage module 50 to the bow's aiming sight 24″, the light source 56 is correspondingly situated atop the fiber-optic cable 34′. Accordingly, when the switching mechanism 48 of the power module 40 is triggered, the corresponding circuit connecting the power source 46 to the light source 56 closes, upon which the light source 56 is energized, leading to the illumination of the target pins 32′ (see FIG. 7) via the fiber-optic cable 34′.

In light of the above, it should be recognized that the power supplied via the power module 40 may be used in various manners with regard to add-on features of the bow. For example, with the above-described embodiment, the power is used in indirect manner. Particularly, the power is used to energize the light source 56 of the linkage module 50, which in turn enables function of the underlying add-on feature (aiming sight 24″) of the bow 10″ during low ambient light periods. Conversely, other embodiments can involve the power being used in direct fashion. For example, with regard to a laser sight, the power can be directly routed to underlying circuitry in furnishing the laser beam. Thus, it should be understood that the add-on features referred to herein, with respect to requiring power for functionality, only dictate that power needs to be routed to the feature from the power module 40, at which point the power is used as needed to bring about the feature's functioning.

In continuing with the above, further focus is directed to the output of the power module 40. With reference back to FIG. 3, the power source 46 of the module 40 can involve one or more batteries. In certain embodiments, as shown, the power source 46 is shown as two coin-shaped cell batteries; however, the invention should not be limited to such. In particular, battery types and/or quantities can be varied as needed, particularly for designs which dictate the power module 40 be linked to a plurality of bow features, i.e., to provide the requisite power therefor. To that end, the sizes (and potentially the locations) of the mounting and enclosure portions 42, 44 of the module 40 may need to be varied in order to accommodate differing configurations of the power source 46. For example, the cavity 44a of the enclosure portion 44 may need to be enlarged. To that end, the enclosure portion 44 may need to be more centrally located relative to the module base 42a of the mounting portion 42 (and its fastening parameters), e.g., the bores 42b defined in the base 42a could be shifted on opposing sides of the cavity 44a to better stabilize the larger cavity 44a (and the power source 46 and switch mechanism 48 therein).

Given the applicable use of the power module 40 with regard to multiple features of the archery bow, in certain embodiments, the module 40 is configured to be centrally-situated on the bow (e.g., on a body 14″ thereof, as shown in FIG. 6). As such, the module 40 can be correspondingly linked to any desired quantity of add-on features with limited lengths of wiring there between. To that end, in certain embodiments as detailed above, there is need for a linkage module 50 forming intermediary between the power module 40 and each of the add-on features. However, whereas the linkage module 50 has been embodied herein with mounting and activation portions 52, 54, in certain embodiments, alternate linkage modules can dictate only having an activation portion. Accordingly, with reference back to FIG. 5, such alternate linkage module design would include a set of leads 51a, 51b extending from the power module 40 and tied at their opposing ends to power connector (e.g., male type, substituted in place of the light source 56 of FIG. 5). To that end, the corresponding archery bow add-on feature (needing power for functionality) would be configured with a corresponding power connector (e.g., female type). Furthermore, if more than one feature required such direct form of powering from the power module 40, the leads 49a, 49b exiting the module 40 could be spliced accordingly. As such, power would be supplied from one master cable (from the power module 40) to a plurality of the bow features (via corresponding linkage modules spliced from the master cable).

In view of the above, corresponding benefits of the power module 40 (as they relate to its output) should be appreciated. Particularly, via the module's use, power can be provided to add-on features in an effective and efficient manner. First off, the underlying features would need not separate power sources. This would be beneficial in that the sizes of these features could be correspondingly streamlined, which would allow flexibility with regard to possible mounting locations for the features on the bow. Further related to the above benefit of not needing separate power sources for each feature, is that there would not be a corresponding duplication of sub-parts amongst power sources for the features. Consequently, there would be a decreased potential of issues arising from the power system. Finally (and further related to the above benefits), in requiring only a single power module 40, the maintenance thereof, e.g., battery replacement, can be a quick and easy exercise.

In further detailing the power module 40, focus is directed to its input. With reference back to FIG. 3, the switch mechanism 48 of the module 40 is situated in the cavity 44a of the module's enclosure portion 44, along with the power source 46. To that end, the switch mechanism 48 represents the module's input. Particularly, when activated or triggered, the switch mechanism 48 connects the power source 46, whereby voltage is then provided between the output leads 49a and 49b. The type of switch used with the power module 40 can depend on when and/or how triggering of power is ultimately warranted. For example, in terms of when such triggering of power is warranted, this would most often involve periods of active use of the bow, e.g., when a user is aiming at a target. With respect to how triggering of power is warranted, as previously alluded to, this would be without adversely affecting the user's use of the bow.

With reference to the aiming sight embodiment described above, the switch mechanism 48 would need to be triggered at least during low ambient light conditions, such that the pin(s) of the sight would be correspondingly illuminated. However, a user may not appreciate how dimly-lit the environment is prior to pulling back the bow drawstring. To that end, it would be quite inconvenient to ask the user to release the drawstring, trigger the switching mechanism 48 of the power module 40, and then again pull back the drawstring. As such, in certain embodiments, the switch mechanism 48 would be triggered any time the user is aiming/shooting at an intended target. For example, in certain embodiments as shown, the switch mechanism 48 can be a pull switch. In such case, the pull switch can be tied to one of the timing cables of the bow, such that when the drawstring is pulled, the switching mechanism 48 is triggered. However, embodiments of the invention should not be limited to pull switches.

It should be appreciated that using a pull switch for the switching mechanism 48, while effective, is an indirect triggering means. Put another way, the user triggers the mechanism 48 via indirect action, as opposed to direct action, such as depressing/flipping a manual switch. To that end, in certain embodiments, a manual switch (not shown) can be alternately used. Use of such manual switch, e.g., toggle, rocker, push button, etc., would be most convenient if located in close proximity to a user's hands during active use of the archery bow. For example, in certain embodiments, such manual switch would be positioned just above the bow grip 13 (of bow 10 of FIG. 1), which the user could easily reach with extended index finger (to depress/flip). As previously noted, in certain embodiments, the power module 40 would be positioned proximate to the bow body 14 (see FIG. 1). Therefore, such manual switch, if located above the grip 13, would also be in close proximity to the power module 40 so as to enable easy connection there between.

Further, in noting the potential use/need of different switches (pull, manual, etc.), and much like the power source 46 further set in the cavity 44a of the enclosure portion 44, the switch mechanism 48 can be varied based on need. For example, the switching mechanism 48 can include one or more switches. To that end, it may not be ideal for all of the add-on features to be activated simultaneously. As such, the switch types and/or quantities would be subject to variance based on quantity and type of add-on features for the archery bow. For example, it may be more appropriate for some of the features to be triggered indirectly via action of the user (such as with drawstring pull), while for other of the features, it would be more appropriate to be directly triggered via user action. As described above, a manual switch could be located outside the power module 40; however, there would be further underlying electrical connections, wiring for each switch. As such, the cavity 44a of the enclosure portion 44 may need to be enlarged correspondingly.

In view of the above, corresponding benefits of the power module 40 (as they relate to its input) should be appreciated. Particularly, via the module's use, power can be triggered for add-on features in effective and efficient manner via use of the switching mechanism 48. As described above, the switching mechanism 48 can be effectively activated via direct and/or indirect action(s) of the user in the course of actively using the bow. Making such triggering action an extension of the standard process of using the bow minimizes risk of compromising the user's success with the bow. In terms of efficiency, as described above, the switching mechanism 48 can involve the use of more than one switch in order to selectively differentiate the add-on features being powered. Moreover, the switching mechanism 48 for the power module 40 is configured to trigger with limited extra action being required from the user, such that triggering the features needing power for functionality is an exercise that is easily and efficiently performed.

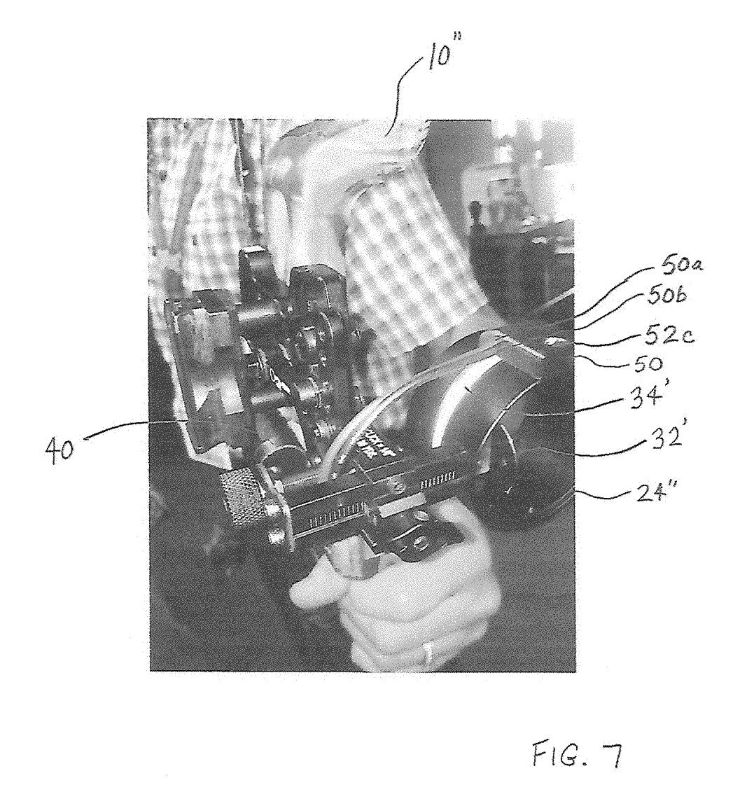

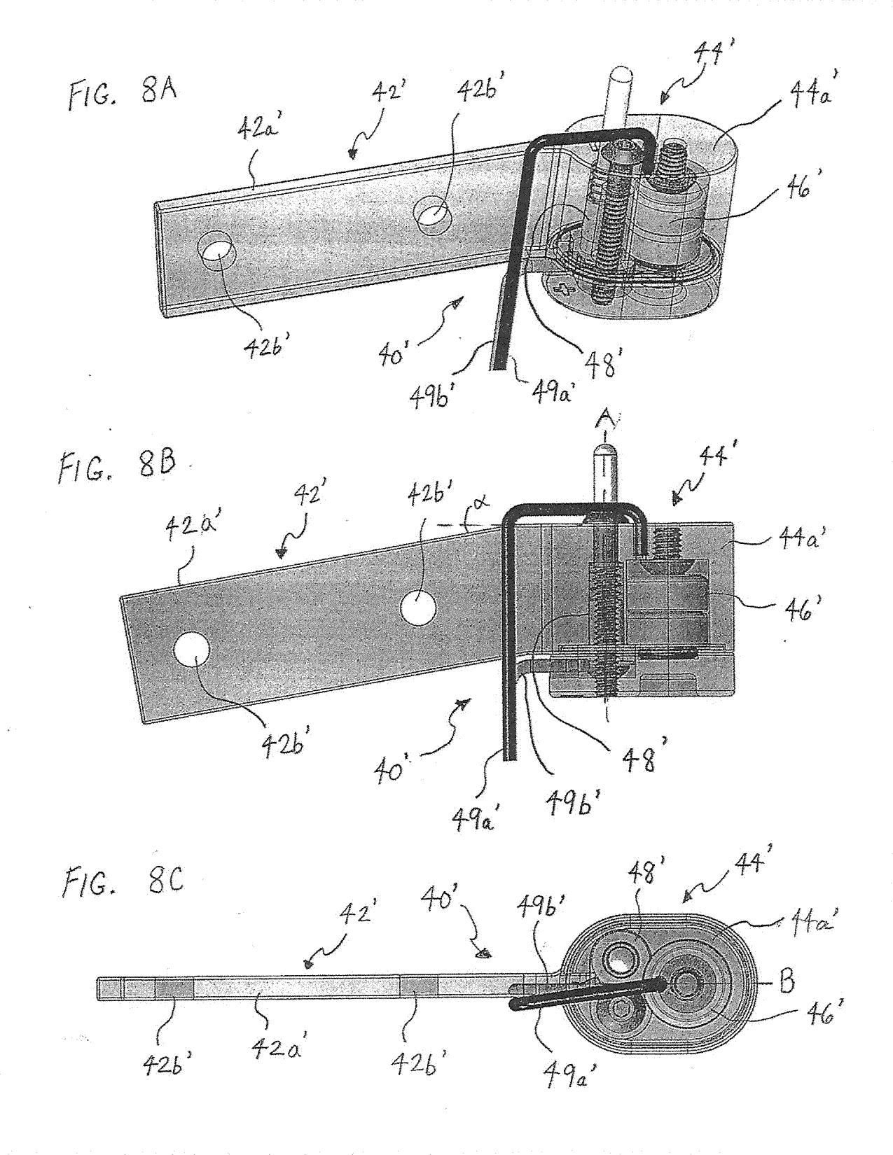

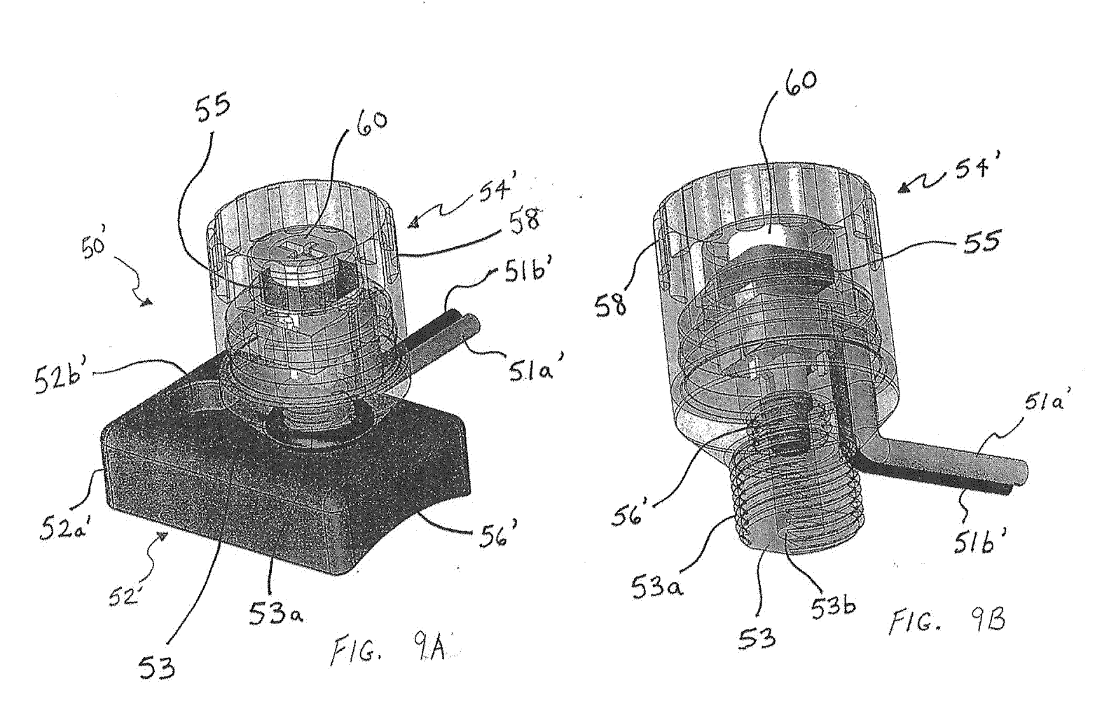

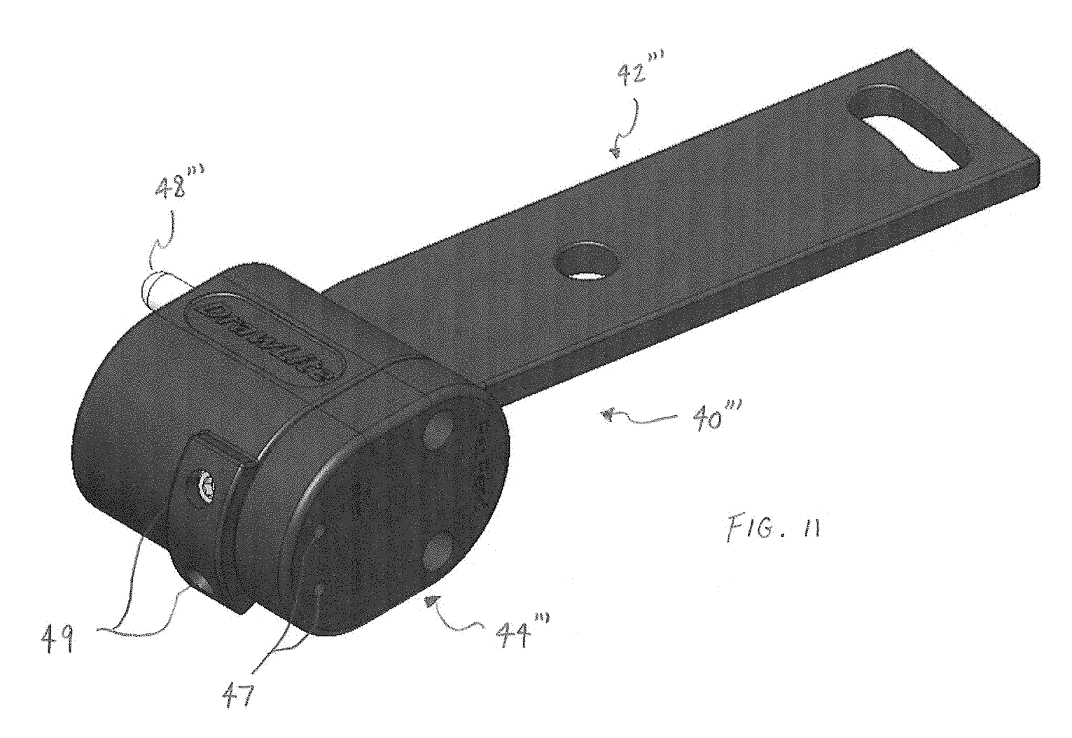

While certain embodiments of power and linkage modules 40, 50 have been described herein with reference to FIGS. 3-7, the description has also alluded to the premise that their designs can vary, e.g., based on corresponding features of the bow. For example, if the power module 40 needs to provide power for a plurality of features, the enclosure portion 44 may need to be enlarged (e.g., to accommodate different power and/or switch configurations) and as a result may need to be situated differently relative to the base 42a of the mounting portion 42. As further exemplified in FIGS. 8A, 8B, and 8C as well as FIGS. 10 and 11, the design of the power module can also vary based on other factors, such as ease of activation and/or mounting. For instance, FIG. 8A shows a perspective view of a further power module 40′ (with its outer walls being shown as transparent) in accordance with certain embodiments of the invention. As illustrated, the power module 40′ (shown in differing views in FIGS. 8B and 8C) generally has the same basic features as the power module 40 of FIG. 3, and the differences of note pertain to the orientation of the mounting portion 42′ relative to the enclosure portion 44′ (or vice versa).

Turning to FIG. 8B and its side view of the power module 40′, the switch mechanism 48′ is shown to involve a pull switch similar to the module 40 of FIG. 3. However, in this module 40′, the mounting portion 42′ (i.e., the base 42a′ thereof) is angled relative to the enclosure portion 44′. Such change in configuration has been found to be more effective for triggering/activation purposes, particularly when a pull switch is used for the switching mechanism 48′. As shown with reference to FIG. 8B, the base 42a′ of the module 40′ extends outward at angle α relative to the longitudinal axis A of the switch mechanism 48′. In certain embodiments, the angle α is at least 15 degrees. Consequently, when using a pull switch for the switch mechanism 48′, the switch is better oriented for effective triggering. Particularly, and with reference back to FIG. 1, but for the segment of the drawstring 20 that is pulled straight back by the user, the other segments of the drawstring 20 (as well as the timing cables 18) move angularly relative to the body 14 of the bow 10. Accordingly, by angling the base 42a′ relative to the switch mechanism 48′, when the base 42a′ is operably coupled to the bow 10, the switch is correspondingly angled, and thus better aligned with an angled pulling or triggering force on the switch (via connection with one of the timing cables) during pull of the drawstring.

Shifting to FIG. 8C and its top view of the power module 40′, the base 42a′ of the mounting portion 42′ is shown to intersect with the enclosure portion 44′ at the midline B thereof. Skilled artisans would appreciate that such configuration of mounting portion 42′ relative to the enclosure portion 44′ enables the power module 40′ to not only be more universal, but also more variable, in its mounting to differing archery bow styles and configurations (e.g., differing bow configurations for right-handed and left-handed people). For example, with reference back to FIG. 7, the power module 40′ would have similar mounting (and have similar representation), regardless of the side of the bow 10″ that the module 40′ is mounted on. Furthermore, with continued reference to FIG. 7 and the module 40 shown mounted therein, if the further power module 40′ were used instead, there would less clearance needed for the enclosure portion 44′. To that end, there is enhanced opportunity for the module 40′ to be tighter to the body of the bow, and less inclined to distract/divert the user's attention when the bow is in use.

Turning next to FIG. 10, a power module 40″ is exemplarily shown which, similar to the power module 40′ of FIGS. 8A-8C, has base 42a″ of mounting portion 42″ shown to intersect with the enclosure portion 44″ at midline thereof. Benefits of such a configuration have already been described. However, in certain embodiments as shown, a slot 45 is defined at outer end of the base 42a″ (as opposed to a circular bore, such as bore 42b′ of module 40′). Accordingly, the position of the module 40″, and more particularly the module's enclosure portion 44″ and its switch mechanism 48″, can be selectively adjusted relative to a bow (on which the module 40″ is mounted). To that end, and for cases in which such adjustment is via pivoting, a pivot point can be defined between the enclosure portion 44″ and outer end of the mounting portion 42″. For example, in certain embodiments, such pivot point can be defined at inner bore 42b″ of the mounting portion 42″ (when fastener, not shown, is used to extend through bore 42b″, so as to link module 40″ to bow). In turn, further fastener is similarly used with the slot 45, whereby the end of the base 42a″ can be selectively adjusted about the fastener to the extent of its travel within the slot 45. As already noted above, by adjusting the base outer end in such manner (about fastener extending within the slot 45), positioning of the module's enclosure portion 44″, and more particularly its switch mechanism 48″, can be correspondingly adjusted, i.e., pivoted, angularly relative to the bow. When the desired position is reached, the fastener extending through the slot 45 (as well as fastener extending through inner bore 42b″) can be tightened such that the power module 40″ is secured in such adjusted position relative to the bow. Consequently, when using a pull switch for the switch mechanism 48″, the switch can be better oriented for effective triggering. This has already been described, in that the switch mechanism 48″ can be better aligned with an angled pulling or triggering force on the switch (via connection with one of the timing cables) during pull of the drawstring.

With continued focus on the power module 40″ of FIG. 10 (yet alternative to its above-described configuration), in certain embodiments, the locations of the inner bore 42b″ and slot 45 defined in the base 42b″ can be switched, or interchanged. To that end, a pivot point can be defined at the outer end of the mounting portion 42″, e.g., via circular bore defined at such end with fastener extending therein (and linking the base 42a″ to the bow), while slot is defined between the enclosure portion 44″ and outer end of the mounting portion 42″ (e.g., at a midpoint there between, or at about the location of inner bore 42b″ as shown in FIG. 10). As would be appreciated, such configuration would enable greater angular adjustment of the switch mechanism 48″ relative to the bow, as warranted.

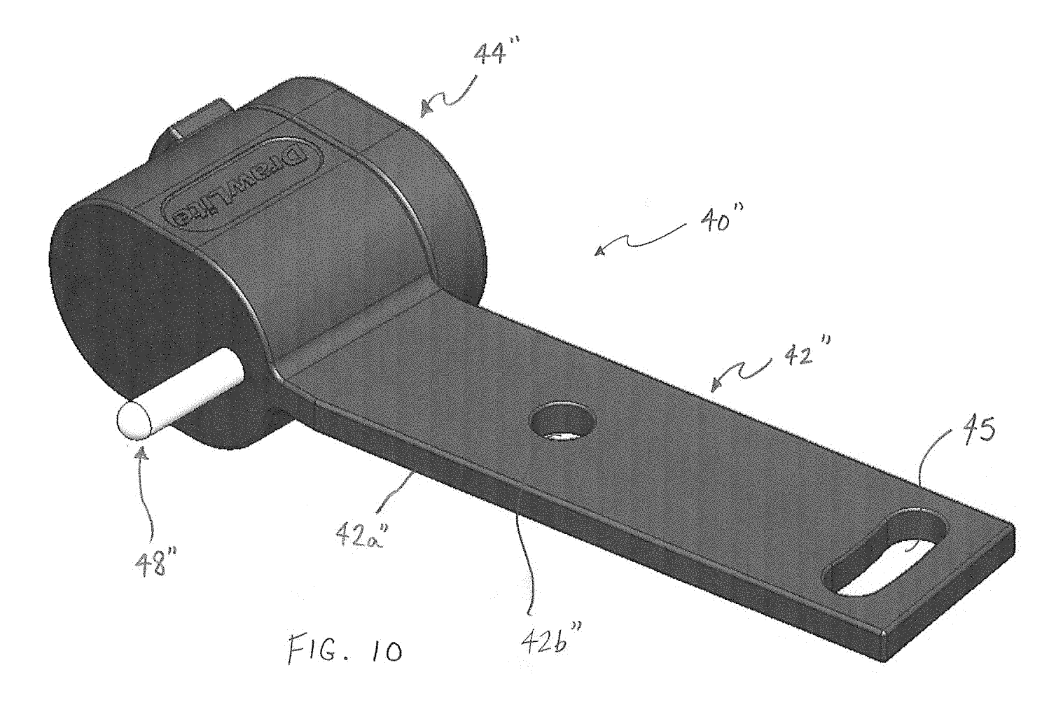

As noted above, the design of the linkage module 50 can also vary based on corresponding features of the bow and/or other factors. For example, as already described herein, the design may vary depending on the use of power by the features of the archery bow. In addition, and as exemplified in FIGS. 9A and 9B, the design of the linkage module can also vary based on enhancements in function and/or applicability. For instance, FIG. 9A shows a perspective view of a linkage module 50′ (with certain outer walls thereof being shown as transparent) in accordance with certain embodiments of the invention. As illustrated, the linkage module 50′ has both a mounting portion 52′ and an activation portion 54′, and has generally the same function as the linkage module 50 of FIG. 5, i.e., to power a light source 56′, yet the assembly is significantly different. FIG. 9B, by way of comparison, illustrates a perspective view of the activation portion 54′ of the module 50′.

Continuing with FIG. 9A, the mounting portion 52′ is used in securing the module 50′ to the corresponding add-on feature of the archery bow. To that end, in certain embodiments as shown, the mounting portion 52′ can be formed of a base 52a′ defined with a bore 52b′ for fastening the module 50′ (via bolt, not shown). There are a few features of note concerning the module 50′, particularly with regard to the activation portion 54′. For example, in certain embodiments as illustrated, a coupling 53 is used with the activation portion 54′ to enable securement to the mounting portion 52′. In addition, the activation portion 54′ has a capsule-like housing, which enables the light source 56′ (e.g., an LED, best shown in FIG. 9B) to be vertically oriented, a typically more efficient orientation for the source 56′ than is horizontal. Further, in certain embodiments, the activation portion 54′ can be sized to hold a potentiometer 55 therein. In incorporating such potentiometer 55 in the circuit design, resistance can made selectively adjustable to the add-on feature (in this case, light source 56′), e.g., by hand via the rotatable outer casing 58, or by tool (e.g., screwdriver) via rotatable inner head 60. In effect, the output for the add-on feature (the light source 56) can be selectively lessened or enhanced (so as to correspondingly impact output at the target pin(s) of the aiming sight). Thus, the linkage module 50′ provides enhancement in function (e.g., via the potentiometer 55) and applicability (via the coupling 53).

Turning to FIG. 9B, as previously noted, it shows the activation portion 54′ of the module 50′. To that end, the coupling 53 is transparently depicted so as to provide more detail of its body. For example, as shown, the coupling can have outer threading 53a to be mated with and received by corresponding bore 52c′ in the mounting portion 52′. Further, the coupling 53 is depicted as defined with an inner bore 53b to provide path of light from the light source 56′ to the fiber optic cable 34′ (e.g., with reference to the embodiment illustrated in FIGS. 6 and 7). What should be further appreciated, however, is such coupling 53 enables the activation portion 54′ to be used independently with add-on features of archery bows, so long as those features have some bore that the coupling 53 can be mated to. To that end, it should be appreciated that the various dimensions of the coupling 53 can be varied as desired for widespread applicability. For example, while such coupling 53 is exemplified for the linkage module 50′ (for energizing light source 56′), such coupling 53 can just as well be applicable with an alternative linkage module design, as previously described, including set of leads 51a, 51b extending from one of the power module 40 (or module 40′, 40″) and tied at their opposing ends to power connector (e.g., male type, substituted in place of the light source 56′ of FIG. 9A), with coupling serving as surrounding securement means for connection between the activation portion 54′ and the add-on feature of the archery bow.

To this point, a variety of embodiments have been described concerning design variations to power module (40, 40′, 40″) as well as linkage module (50, 50′) interconnecting power module and add-on feature. To that end, in certain embodiments, some form of wired electrical connection is provided between the modules for directly or indirectly powering the add-on feature. For example, the linkage module can have connection wires (stemming from the activation portion of the linkage module), which extend to output of the switching mechanism of the power module (so as to be directly connected thereto) or alternately could be tied to corresponding connection wires stemming from such output. FIG. 11 depicts a power module 40′″ which enables easier connection with such output of the switching mechanism. As shown, the enclosure portion 44′″ of the module 40′″ is defined with a plurality of openings 47 sized to accept wire lead endings. Such openings 47 are positioned to enable contact to be made between such inserted wire endings and output connectors of the switching mechanism 48′″ without needing to take apart the enclosure portion 44′″ of the module 40′″.

Upon inserting such wire endings into the openings 47, in certain embodiments as shown, couplings can be provided on the enclosure portion 44′″ for connecting the wire endings with the switching mechanism 48′″. For example, the couplings can involve set screws 49, which can be threaded in the enclosure portion 44′″ in proximity to such openings 47, such that when the wire endings are inserted into the openings 47, the set screws 49 can be tightened (inward relative to the enclosure portion 44′″) so as to provide contact between the wire endings and corresponding output terminals of the switch mechanism 48″, providing a quicker and easier means of wire connection to the power module 40′″. In certain embodiments, the openings 47 and set screws 49 are located on side of the enclosure portion 44′″ (e.g., on cover and corresponding side thereof, respectively) opposite where the switch mechanism 48′″ protrudes, so as to avoid possible interference with triggering of the switch mechanism 48′″. However, while keeping with that principle, the exact locations of the openings 47 and couplings 49 can be varied as desired.

Thus, embodiments of the invention are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention.

What is claimed is:

1. A power module for an archery bow comprising:
a mounting portion having a base configured for securing the module to an archery bow;
an enclosure portion extending from the base and defining a cavity; and
a power source and a switch mechanism, the power source and switch mechanism situated in the cavity of the enclosure portion, the switch mechanism forming an input such that only by triggering the switch mechanism is power provided from the module, the power source forming an output whereby the power is provided by the module via the power source to one or more features requiring power for functionality, the one or more features each mounted separate and at a distance from the power module;
wherein the triggering of the switch mechanism stems from one or more of a direct action and an indirect action performable by the user during active use of the archery bow.

2. The power module of claim 1 wherein the one or more features comprises an aiming sight, the sight comprising one or more targeting pins configured to illuminate from the power provided from the module.

3. The power module of claim 2 further comprising a linkage module interconnecting the power module and the aiming sight, the linkage module comprising an activation portion that is coupled to the aiming sight.

4. The power module of claim 3 wherein the linkage module incorporates a potentiometer that is selectively adjustable to correspondingly vary level of the power provided from the power module.

5. The power module of claim 4 wherein the aiming sight comprises fiber-optic cable being joined to the one or more targeting pins, the activation portion of the linkage module comprising a light source which when powered illuminates the pins via the fiber-optic cable.

6. The power module of claim 1 wherein the one or more features comprise a plurality of features, the power source of the power module comprising one or more batteries capable of powering the plurality of features simultaneously.

7. The power module of claim 1 wherein the triggering of the switch mechanism stems from indirect action of the user, the indirect action involving an action performed by the user during normal course of using the archery bow to shoot at a target.

8. The power module of claim 7 wherein the indirect action is the user pulling back a drawstring of the bow, the switch mechanism being a pull switch connected to a timing cable of the archery bow via intermediary cable and having movement corresponding to that of the drawstring.

9. The power module of claim 8 wherein the indirect action is the user pulling back a drawstring of the bow, the switch mechanism being a pull switch that has an angled orientation with respect to the drawstring.

10. The power module of claim 1 wherein the triggering of the switch mechanism stems from direct action of the user, the direct action involving an action that is performable by the user without hands of the user being moved from corresponding positions when using the archery bow to shoot at a target.

11. The power module of claim 10 wherein the direct action is the user manually activating a switch, the switch mechanism comprising a manual switch located proximate to grip of the archery bow and reachable by the user via index finger of grip hand.

12. A power module for an archery bow comprising:
a mounting portion having a base configured for securing the module to an archery bow;
an enclosure portion extending from the base and defining a cavity;
a power source and a switch mechanism, the power source and switch mechanism situated in the cavity of the enclosure portion, the switch mechanism forming an input such that only by triggering the switch mechanism is power provided from the module, the power source forming an output whereby the power is provided by the module via the power source to one or more features requiring power for functionality, the one or more features each mounted separate and at a distance from the power module; and
a linkage module interconnecting the power module and at least one of the one or more features, the linkage module comprising an activation portion for the at least one feature.

13. The power module of claim 12 wherein the linkage module incorporates a potentiometer that is selectively adjustable to correspondingly vary level of power provided from the power module to the at least one feature.

14. The power module of claim 12 wherein the triggering of the switch mechanism stems from one or more of a direct action and an indirect action performable by the user during active use of the archery bow.

15. The power module of claim 14 wherein the triggering of the switch mechanism stems from indirect action of the user, the indirect action involving an action performed by the user during normal course of using the archery bow to shoot at a target.

16. The power module of claim 15 wherein the indirect action is the user pulling back a drawstring of the bow, the switch mechanism being a pull switch connected to a timing cable of the archery bow via intermediary cable and having movement corresponding to that of the drawstring.

17. The power module of claim 15 wherein the indirect action is the user pulling back a drawstring of the bow, the switch mechanism being a pull switch that has an angled orientation with respect to the drawstring.

18. The power module of claim 14 wherein the triggering of the switch mechanism stems from direct action of the user, the direct action involving an action that is performable by the user without hands of the user being moved from corresponding positions when using the archery bow to shoot at a target.

19. The power module of claim 14 wherein the one or more features comprises an aiming sight, the sight comprising one or more targeting pins configured to illuminate from the power provided from the module.

20. The power module of claim 19 wherein the aiming sight comprises fiber-optic cable being joined to the one or more targeting pins, the activation portion of the linkage module comprising a light source which when powered illuminates the pins via the fiber-optic cable.
